(19) United States
(12) Patent Application Publication
(10) Pub. No.: US 2016/0361804 A1
(43) Pub. Date: Dec. 15, 2016

(54) ANGLED ROD FOR A HAND TOOL

(71) Applicant: Tsai Fa Liu, Taichung (TW)

(72) Inventor: Tsai Fa Liu, Taichung (TW)

(21) Appl. No.: 14/740,233

(22) Filed: Jun. 15, 2015

(51) Int. Cl. B25B 23/00; B25B 15/02

(52) U.S. Cl. CPC B25B 23/0035; B25B 15/02

(57) ABSTRACT

An angled rod for a hand tool comprising a driving part having a driving end for driving a screw, an angled connection part, and a tool-mounting part for connecting to a driving tool. The tool-mounting part is angularly extended to the driving part such that the tool-mounting part and the driving part are non-parallel to each other.

### BACKGROUND OF THE INVENTION

1. Fields of the Invention

The invention relates to an angled rod for a hand tool, and more particularly, to a structure in which the tool-mounting part and the driving part are non-parallel to each other so that an additional (force) moment is created to ensure an easy and a stable tightening/loosening operation.

2. Description of the Related Art

Firstly, we take a general screwdriver (not shown) as example. As we know, the screwdriver has a handle at one end thereof for the operator to apply the force and a force-applying shaft at the other end thereof. A slotted head or a Phillips head is formed at the tip of the screwdriver for tightening or loosening the screws (not shown). The “angled rod” according to the invention is something like the L-shaped Allen wrench. As shown in FIG. 8, both ends of the conventional Allen wrench 10 can be used to drive the hexagonal screws according to different work environment and requirements. When the operator holds the long shaft 11 to apply his force and the short shaft 12 is in contact with the screw, a larger moment can be created for an operation with less force and greater driving torque, but otherwise it does not have this effect. As shown in FIG. 9, a T-shaped wrench 20 is designed to obtain a better torque by means that two shaft members 21, 22 are perpendicular to each other. Meanwhile, the handle shaft 22 has a predetermined length to produce a greater moment for achieving the operation with less force.

From the above brief description, we can easily understand that the length of the moment arm plays an important roll when the hand tool is designed to achieve a better effectiveness and the torque strength.

As shown in FIGS. 10 and 11, a conventional angled rod 30 for a hand tool includes a driving part 32 (attachable with a screwdriver bit 36) having a driving end 31 for driving a screw, an angled connection part 33, and a tool-mounting part 34 for connecting to a driving tool 35. The tool-mounting part 34 and the driving part 32 are parallel to each other.

As shown in FIG. 10, the extension distance L1 between axles of the driving part 32 and the tool-mounting part 34 corresponds to the length of the moment arm. The longer the moment arm is, the less force has to be applied. Due to the integral construction of the driving part 32 and the tool-mounting part 34, the only way to increase the length of the extension distance L1 between the driving part 32 and the tool-mounting part 34 is the extension of the angled connection part 33. However, this design tends to increase the width of the product and occupy much space, thereby causing difficulty in use. The moment arm can't fulfill the use requirements when the width thereof is not increased.

As shown in FIGS. 12 and 13, an angled rod 30 is secured to a handgrip 35 by means of a pivoting device 37 such that the angled rod 30 can be swiveled in a perpendicular position relative to the handgrip 35, thereby creating a structure similar to the T-shaped wrench 20 and resolving the problem with the insufficient moment of the conventional angled rod 30. This improvement deserves praise and commendation. However, it also causes additional problems with the high manufacturing costs and the complicate assembly procedures. In addition, the connection only through the pivoting device 37 has the problem of low load strength and, therefore, easily fails.

### SUMMARY OF THE INVENTION

An object of the invention is to provide an angled rod for a hand tool for obtaining an increased moment arm by means that a certain change of angle is applied without increasing the production cost due to the complicated assembly procedure.

According to the invention, an angled rod for a hand tool includes a driving part having a driving end for driving a screw, an angled connection part, and a tool-mounting part for connecting to a driving tool. The tool-mounting part is angularly extended to the driving part such that the tool-mounting part and the driving part are non-parallel to each other.

### BRIEF DESCRIPTION OF THE DRAWINGS

The accomplishment of this and other objects of the invention will become apparent from the following description and its accompanying drawings of which:

FIG. 1 is a schematic view of a first embodiment of the invention;

FIG. 2 is a schematic view of the operation state of the first embodiment of the invention according to FIG. 1;

FIG. 3 is a schematic view of a second embodiment of the invention;

FIG. 4 is a schematic view of a third embodiment of the invention;

FIG. 5 is a schematic view of a fourth embodiment of the invention;

FIG. 6 is a schematic view of a fourth embodiment of the invention;

FIG. 7 is a schematic view of a fourth embodiment of the invention;

FIG. 8 is a schematic view of a conventional L-shaped Allen wrench;

FIG. 9 is a schematic view of a conventional T-shaped wrench;

FIG. 10 is a schematic view of a conventional angled rod for a hand tool;

FIG. 11 is a schematic view of the conventional angled rod (according to FIG. 10) in an assembly position;

FIG. 12 is a schematic view of another conventional angled rod in the assembly position; and

FIG. 13 is a schematic view of the conventional angled rod (according to FIG. 12) in a perpendicular position relative to the handgrip.

### DETAILED DESCRIPTION OF THE PREFERRED EMBODIMENT

The present invention will now be described in more detail hereinafter with reference to the accompanying drawings that show various embodiments of the invention.

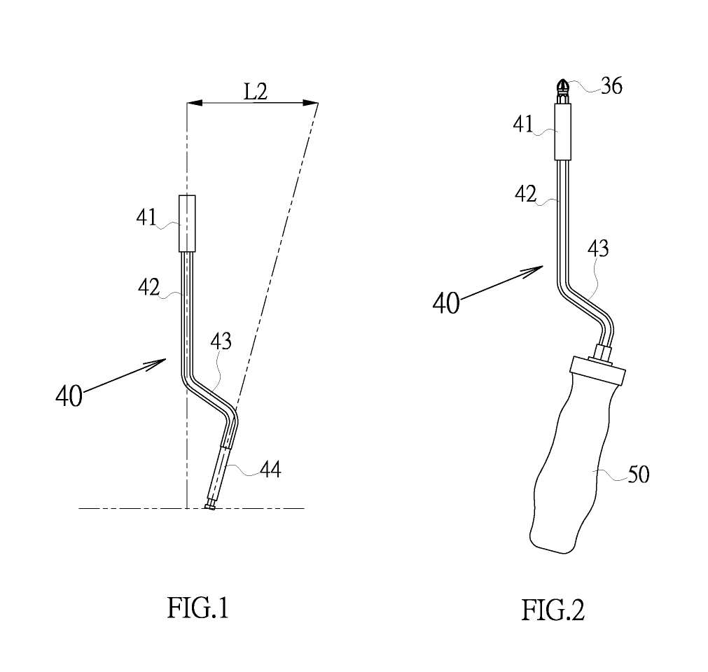

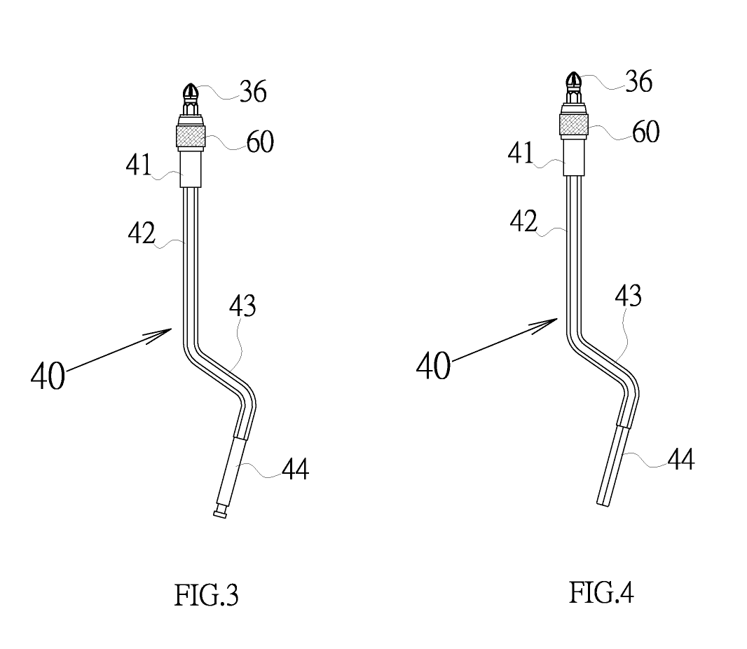

Referring to FIGS. 1 and 2, an angled rod for a hand tool in accordance with a preferred embodiment of the invention includes a driving part 42 having a driving end 41 for driving a screw, an angled connection part 43, and a tool-mounting part 44 for connecting to a driving tool 50. According to the invention, the tool-mounting part 44 is angularly extended to the driving part 42 such that the tool-mounting part 44 and the driving part 42 are non-parallel to each other.

As shown in FIG. 2, a distance L2 between two axles of the driving part 42 and the tool-mounting part 44 is much larger than that in the conventional similar products. In other word, the angled rod according to the invention has a longer “force arm” with which a larger moment is produced for the force-saving effect. Meanwhile, the overall load strength won't be reduced. In use, the design according to the invention contributes to initially loosen screws and to conduct the tightening work and the final driving action without any other support of tools.

It is confirmed by real tests that the tool-mounting part 44 is preferably angled from 5° to 60° degrees.

According to the invention, a plurality of embodiments can be made to meet all of the requirements. As shown in FIG. 1, the driving end 41 can be formed to receive a screwdriver bit 36. As shown in FIG. 4, the driving end 41 is fitted with a locking unit 60 for receiving the screwdriver bit 36 in place and preventing it from loosening. The locking unit 60 belongs to the prior art so that no further description thereto is given hereinafter.

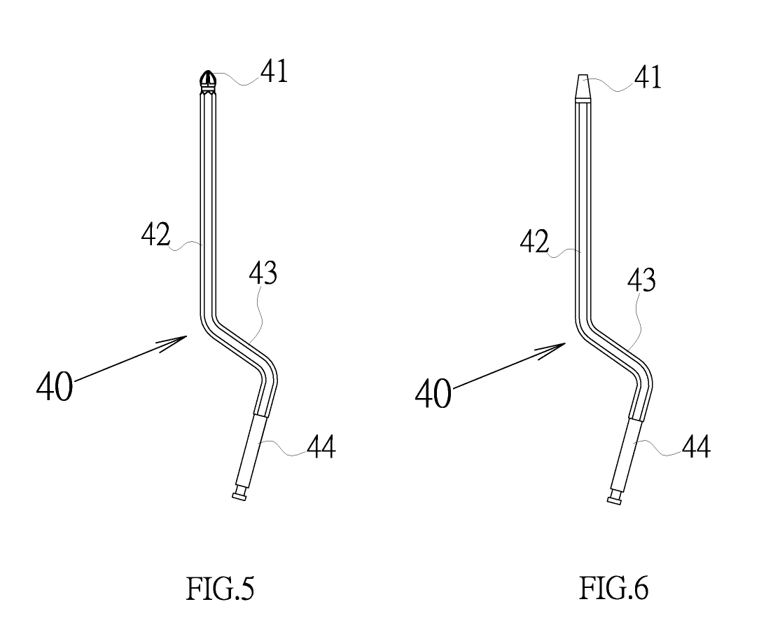

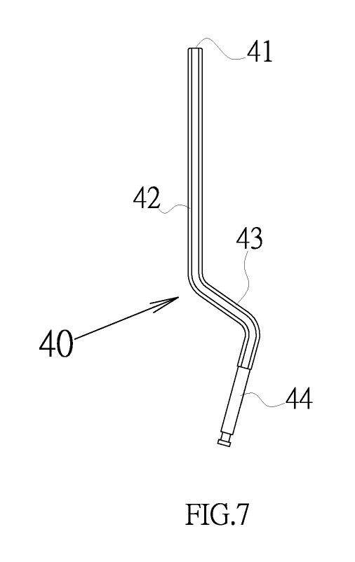

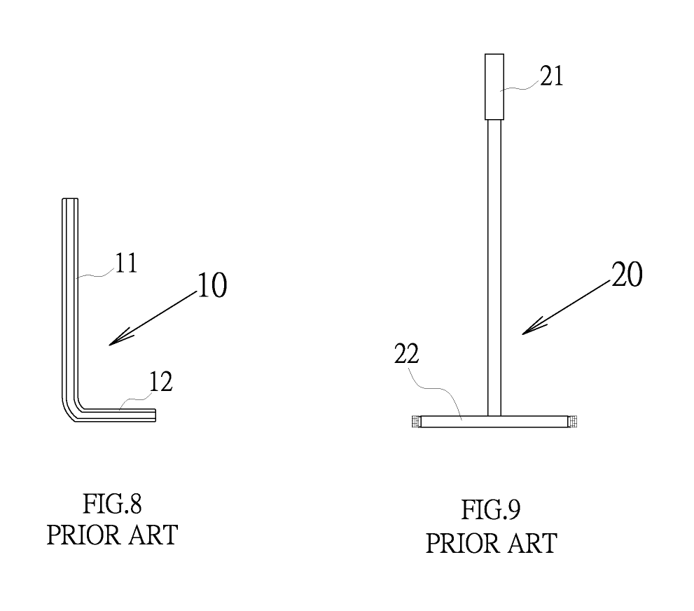

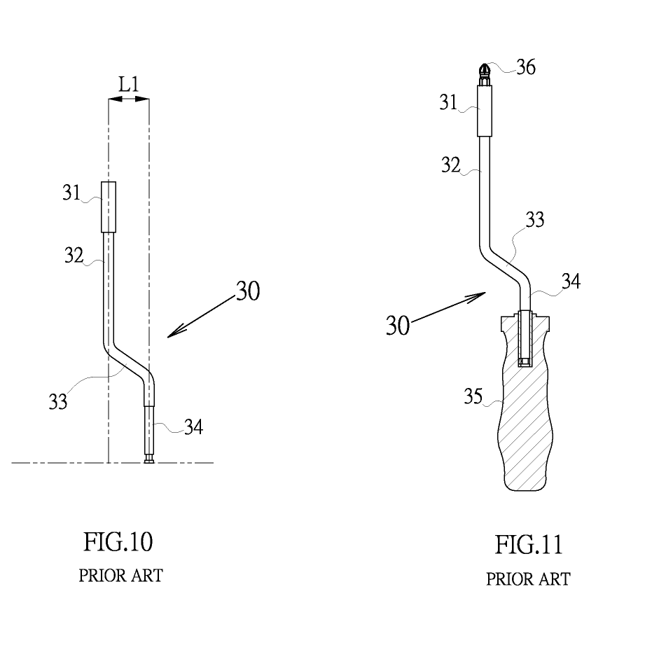

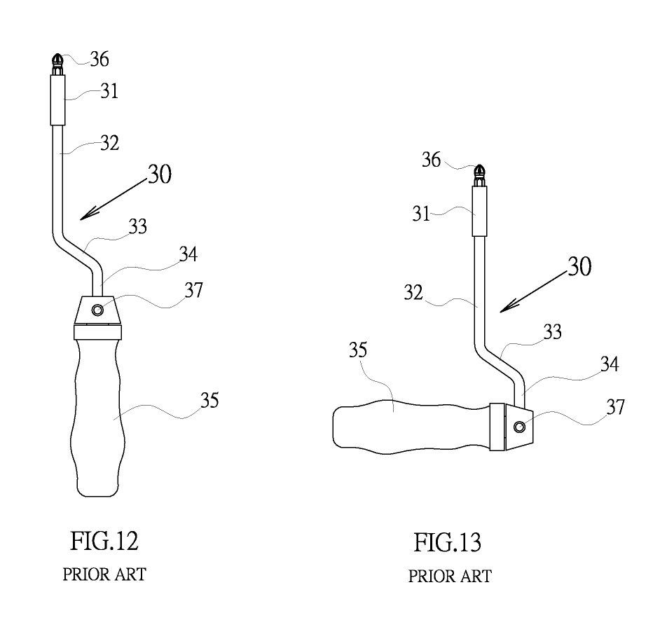

As shown in FIG. 4, the tool-mounting part 44 according to the invention is polygonally formed such that a connecting sleeve (not shown) can slip over the tool-mounting part 44. As shown in FIGS. 5, 6 and 7, the driving end 41 is formed as Phillips bit, slotted bit or Allen wrench for driving different types of screws.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An angled rod for a hand tool comprising a driving part having a driving end, an angled connection part, and a tool-mounting part, the tool-mounting part being angularly extended to the driving part such that the tool-mounting part and the driving part are non-parallel to each other.

2. The angled rod for a hand tool as recited in claim 1, wherein the tool-mounting part is preferably angled from 5° to 60° degrees.
